(19) United States
(12) Patent Application Publication
(10) Pub. No.: US 2010/0279259 A1
(43) Pub. Date: Nov. 4, 2010

(54) MULTIPLICATION TEACHING AID

(76) Inventor: Martha Thorpe, Richmond Heights, OH (US)

Correspondence Address: FAY SHARPE LLP, 1228 Euclid Avenue, 5th Floor, The Halle Building, Cleveland, OH, 44115, US

(21) Appl. No.: 12/433,233

(22) Filed: Apr. 30, 2009

(51) Int. Cl. G09B 1/00

(52) U.S. Cl. 434/209

(57) ABSTRACT

A teaching aid for facilitating in the learning and comprehension of multiplication tables is provided. The teaching aid includes a plurality of generally flat tabs including a front surface and a rear surface. At least one of the front surface or the rear surface is capable of having indicia displayed thereon. The tabs include a first end and a second end, the second end including an aperture. A retaining member extends through the aperture of the second end of each of the plurality of tabs for resiliently holding the plurality of tabs together while permitting each of the tabs to rotate with respect to the other. A plurality of indicia are displayed on at least one of the front or rear surface. Wherein, the indicia correspond to a graphical representation of the product of a first number and a second number to be multiplied.

### BACKGROUND

The present exemplary embodiment relates to the field of teaching aids. It finds particular application in conjunction with methods and systems for teaching students how to multiple basic integers (i.e., whole numbers between zero (0) and ten (10)). However, it is to be appreciated that the present exemplary embodiment is also amenable to other like applications.

Various types of teachings aids are available for teaching students how to multiply basic integers (e.g., flash cards, multiplication tables, etc.). However, these aids or methods have numerous disadvantages. For example, a basic multiplication table is plain and requires repetitive and mundane memorization of a series of numbers and their respective products. Such a teaching method does not stimulate the learning process and fails to engage or capture a student's attention for extended periods, thus making the learning process less effective and more time consuming. Moreover, while some students are adept at auditory learning and/or plainly memorizing the associations of various numbers (as in a basic multiplication table), many other students are more adept to learning by fully comprehending the association by some visual, graphical, or tangible representation of the numbers being multiplied. In addition, many teaching aids involve several pieces or cards (e.g., a deck of flash cards), and are not suitable for most teaching environments because pieces of the teaching aid can be easily misplaced, disorganized, or destroyed.

Accordingly, it is an object of the present invention to develop a new and enhanced multiplication teaching aid which will overcome the foregoing difficulties and others while providing better and more advantageous results.

### SUMMARY

According to one aspect of the present invention, a teaching aid for facilitating in the learning and comprehension of multiplication tables is provided. The teaching aid includes a plurality of generally flat tabs including a front surface and a rear surface. At least one of the front surface or the rear surface is capable of having indicia displayed thereon. The tabs include a first end and a second end, the second end including an aperture. A retaining member extends through the aperture of the second end of each of the plurality of tabs for resiliently holding the plurality of tabs together while permitting each of the tabs to rotate with respect to the other. A plurality of indicia are displayed on at least one of the front or rear surface. Wherein, the indicia correspond to a graphical representation of the product of a first number and a second number to be multiplied.

According to another aspect of the present invention, a method of teaching a student how to multiply using a teaching aid is provided. The method includes providing the teaching aid with a plurality of tabs. The tabs bear indicia that graphically represent the product of a first number to be multiplied by a second number to be multiplied. The first number to be multiplied corresponds to a first set of indicia and the second number to be multiplied corresponds to a second set of indicia. The teaching aid is presented to the student. The association of the product between the first number to be multiplied and the second number to be multiplied and the first set of corresponding indicia and the second set of corresponding indicia, is explained to the student.

Still other aspects of the invention will become apparent from a reading and understanding of the detailed description of the preferred embodiments hereinbelow.

### BRIEF DESCRIPTION OF THE DRAWINGS

The present invention may take physical form in certain parts and arrangements of parts, preferred embodiments of which will be described in detail in this specification and illustrated in the accompanying drawings which form a part of the invention.

FIG. 1 is a perspective view of a multiplication teaching aid for the 2's multiplication table depicted in an open or fanned configuration, according to the present invention.

FIG. 2 is a perspective view the teaching aid of FIG. 1 in a collapsed or stacked configuration.

FIG. 3 is an exploded view of a plurality of tabs of the teaching aid of FIG. 1, each of the plurality of tabs illustrating a set of numbers to be multiplied, a product of the set of numbers to be multiplied, and a set of indicia corresponding to the product of the set of number to be multiplied.

FIG. 4 is a front view of the teaching aid of FIG. 1.

FIG. 5 is a front view of another embodiment of a multiplication teaching aid, illustrating the 3's multiplication table.

FIG. 6 is a front view of another embodiment of a multiplication teaching aid, in a partially collapsed state, illustrating the 4's multiplication table.

FIG. 7 is a front view of another embodiment of a multiplication teaching aid, in a partially collapsed state, illustrating the 5's multiplication table.

FIG. 8 is a front view of another embodiment of a multiplication teaching aid, in a partially collapsed state, illustrating the 6's multiplication table.

FIG. 9 is a front view of another embodiment of a multiplication teaching aid, in a partially collapsed state, illustrating the 7's multiplication table.

FIG. 10 is a front view of another embodiment of a multiplication teaching aid, in a partially collapsed state, illustrating the 8's multiplication table.

FIG. 11 is a front view of another embodiment of a multiplication teaching aid, in a partially collapsed state, illustrating the 9's multiplication table.

FIG. 12 is a front view of another embodiment of a multiplication teaching aid, similar to that of FIG. 3, illustrating raised indicia for a partial series of the 2's multiplication table.

FIG. 13 is a side view of the multiplication teaching aid of FIG. 12 further illustrating the raised indicia.

### DETAILED DESCRIPTION

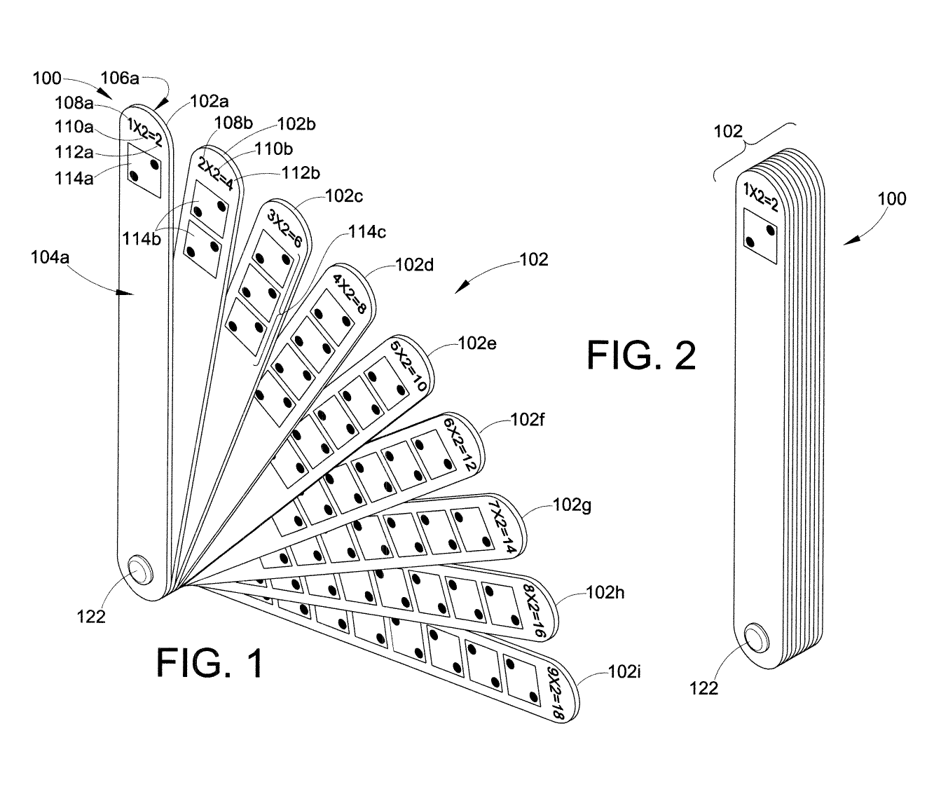

With reference to FIG. 1, a first embodiment of a teaching aid 100 is shown. Generally, the teaching aid 100 includes a plurality of tabs 102. Each of the individual tabs 102a-102i of the plurality of tabs 102 include a first or forward surface 104 and a second or rear surface 106. The plurality tabs 102 may be made from any material suitable for carrying or displaying printed and/or embossed images, icons, or other indicia. In addition, the material used for form the tabs 102 can be any sheet material that is generally flat, flexible and resilient (e.g., metal, plastic, vinyl, laminated paper, durable wood, etc.) Furthermore, the material chosen could have a relatively low coefficient of friction and or be coated with a non-stick material, such as PTFE (a/k/a, Teflon®) or any other suitable non-stick and non-toxic material.

With continued reference to FIG. 1, the teaching aid 100 generally illustrates a multiplication series for the number two (2). Specifically, a multiplication series for the number two (2) is illustrated with respect to the range of integer based numbers beginning at one (1) and ending at nine (9). With particular reference to the first tab 102a of the plurality of tabs 102 of the teaching aid 100, a first number 108 is multiplied by a second number 110 to produce a resultant product 112. Here, the first number is the number one (1) and the second number is the number two (2). Of course, the resultant product 112 is itself, the number two (2). Just below this equation or headline of text (which indicates the numbers to be multiplied), is a graphical representation or icon 114 which corresponds to the resultant product of the first and second numbers 108, 110. By way of example only, the icon or graphical representation illustrated in FIG. 1 (as well as FIGS. 2-6), involves the use of one side or face of a playing die. Here, the icon 114 used for the plurality of tabs 102, as illustrated in FIG. 1, involves the use of the side of a playing die corresponding to the number two (2).

Now with reference to the second tab 102b of the plurality of tabs 102 in FIG. 1, a first number 108b to be multiplied is the number two (2) (as opposed to one (1) as illustrated in the first tab 102a) and the resultant product 112b is four (4). As such, the graphical representation or icons 114b illustrate a quantity of icons corresponding to the first number 108b and each having or displaying a value corresponding to the second number 110b. Similarly, the third tab 102c of the plurality of tabs 102 includes a quantity of three icons 114c which all display the value two (2) of a playing die. In this manner, a student can visually correlate or conceptualize the meaning of a first number being multiplied by a second number and thereby associate those numbers to their resultant product. In the case, for instance, of the third tab 102c, a student would observe the first number three (3) being multiplied by a second number two (2) resulting in a product of six (6) and would correlate this to three playing dies each having two individual dots therein (which indicates a value of two (2)) and thus be able to comprehend or associate the meaning of such numerical representation.

Collectively, the tabs 102 can complete a multiplication series for a given number. For example, where the series involves the multiplication of the number two (2), each tab 102a-102i would successively illustrate the multiplication of 1×2, 2×2, 3×2, 4×2, 5×2, and so forth. Thus, for example, the forth tab 102d would illustrate the value of 4×2 and illustrate it having four playing die, each containing two dots so that when the dots are counted, the sum of the dots equals the resultant product captioned on the tab. Similarly, the fifth tab 102e graphically illustrates the multiplication of 5×2, the sixth tab 102f illustrates the multiplication of 6×2, the seventh tab 102g illustrates the multiplication of 7×2, the eighth tab 102h illustrates the multiplication of 8×2 and the ninth tab 102i illustrates the multiplication of 9×2.

Now with reference to FIG. 2, the plurality of tabs 102 of the teaching aid 100 are illustrated in a closed state, so that the individual tabs are collapsed or are in line with one another, and thus, can be conveniently stored or transported. Furthermore, the collapsible nature of the teaching aid also helps to protect the tabs from damage due to rough handling (i.e., from being ripped or torn).

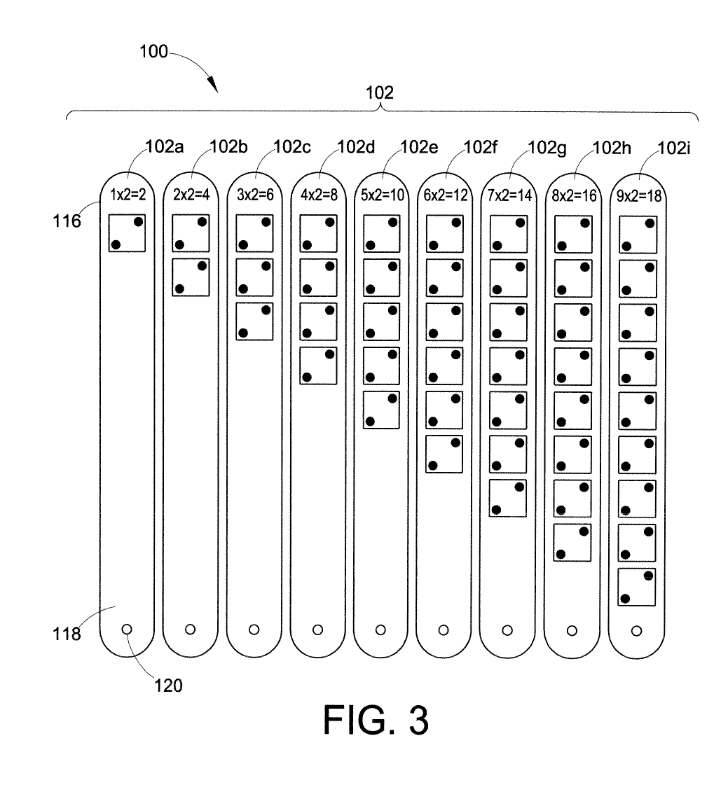

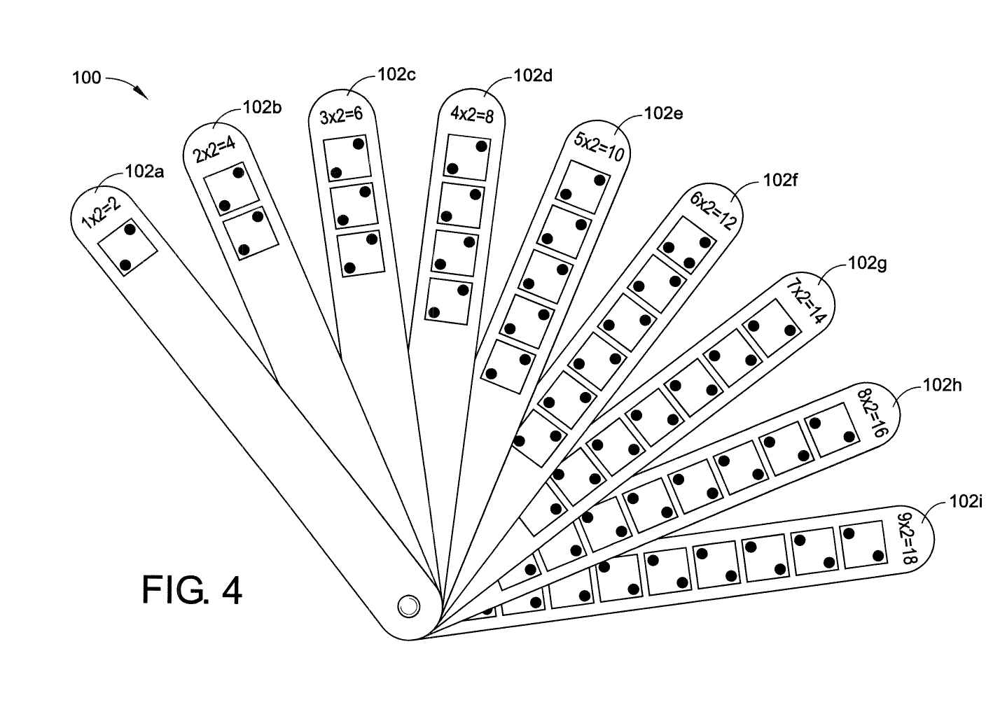

Now with reference to FIG. 3, the teaching aid 100 is shown in an exploded view such that the plurality of tabs 102 have been disjoined and arranged side-by-side. Each of the tabs 102a-102i includes a first end 116 and a second end 118. As illustrated, the first end 116 may include or display the text equivalent of the numbers being multiplied and their resultant product, while the second end 118 may include an aperture 120 for receiving a retaining element or member 122 (as illustrated in FIGS. 1 and 2). In this way, the individual tabs 102a-102i may be sequentially arranged so that their second ends 118 and their respective apertures 120 are aligned so as to receive the retaining member. The retaining member can be made from any number of materials, including but not limited to wood, steel or plastic. Whatever manner is chosen, the retaining member should be arranged or adjusted so as to permit the individual tabs to rotate about their respective ends. This enables the user or student to fan the tabs in or out so that any or all tabs can be viewed and studied without impairment. By way of example, the teaching aid 100 is shown in a partially fanned out state in FIG. 4. In that Figure, nearly all of the individual tabs 102a-102i can be viewed without impairment. In this manner, as the various tabs are fanned out, the student can see the groupings and progression which will aid in the learning process.

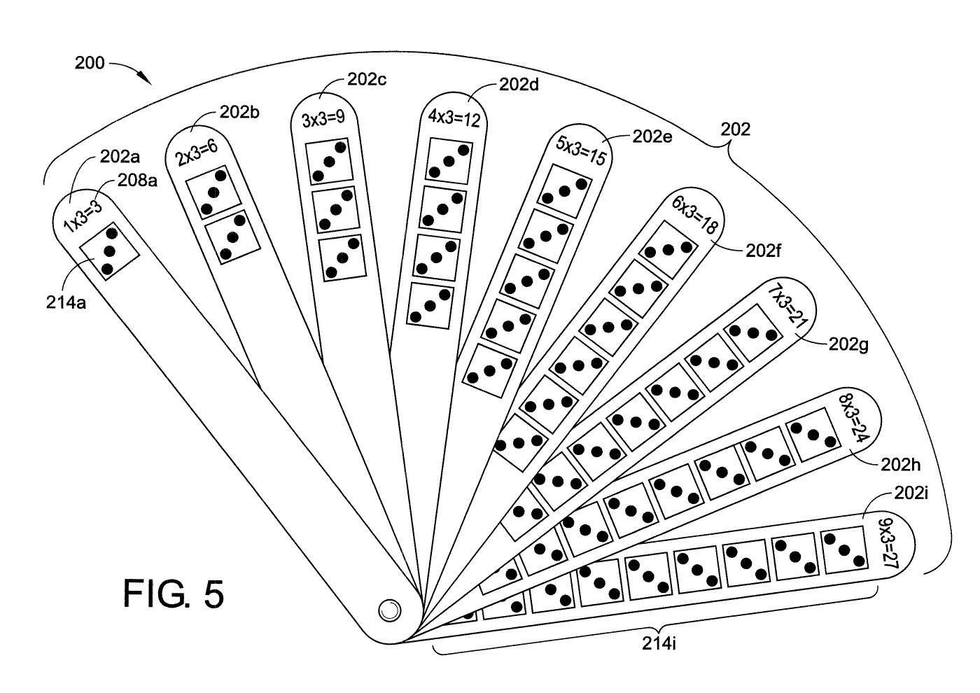

Now with reference to FIG. 5, a second embodiment of a teaching aid 200 is shown resembling in many respects the first embodiment of the teaching aid 100 illustrated in FIG. 1. As with the first embodiment, the teaching aid 200 includes a plurality of tabs 202, each representing a set of first and second numbers to be multiplied. As illustrated here, the multiplication series from 1 through 9 for the number three (3) is shown. Corresponding to the multiplication series of the number 3, is a graphical representation or icon 214 of a surface of a playing die representing the number three (3). Accordingly, for the first tab 202a, only a single playing die 214a is shown since the first number to be multiplied 208a is the number one (1). The multiplication series of the second embodiment ends with the multiplication of the first and second numbers 9×3, respectively, as illustrated on the ninth tab 202i. In particular, the ninth tab 202i illustrates nine individual icons 214i corresponding to the side of a playing die having the value three (3). Similarly, the remaining tabs 202b-202h also illustrate a commensurate number of icons corresponding to the respective first number being multiplied.

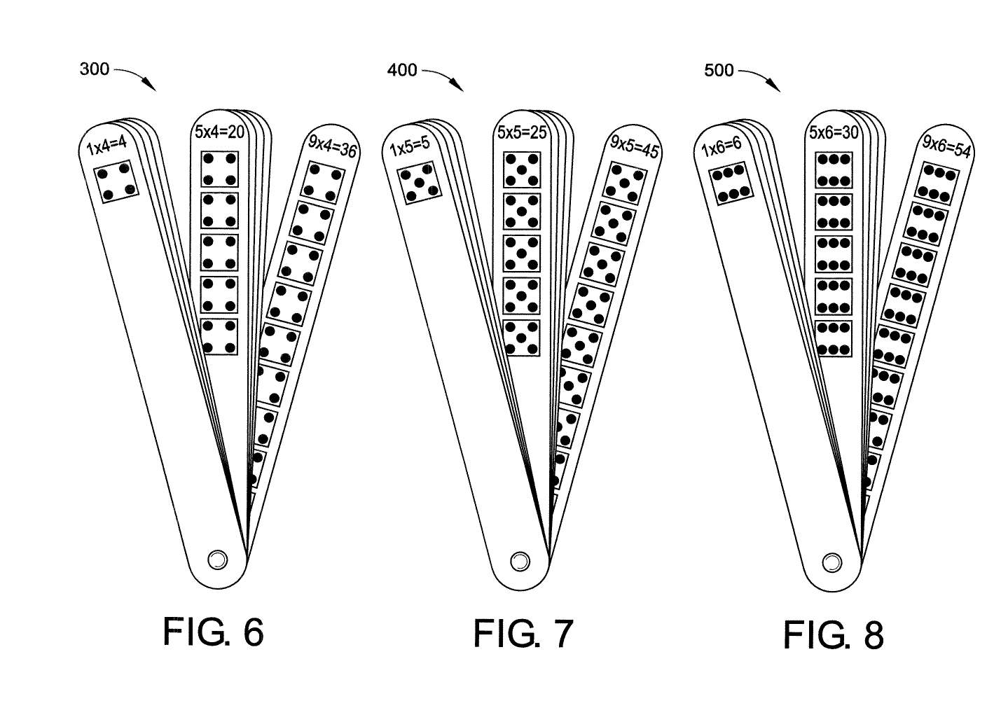

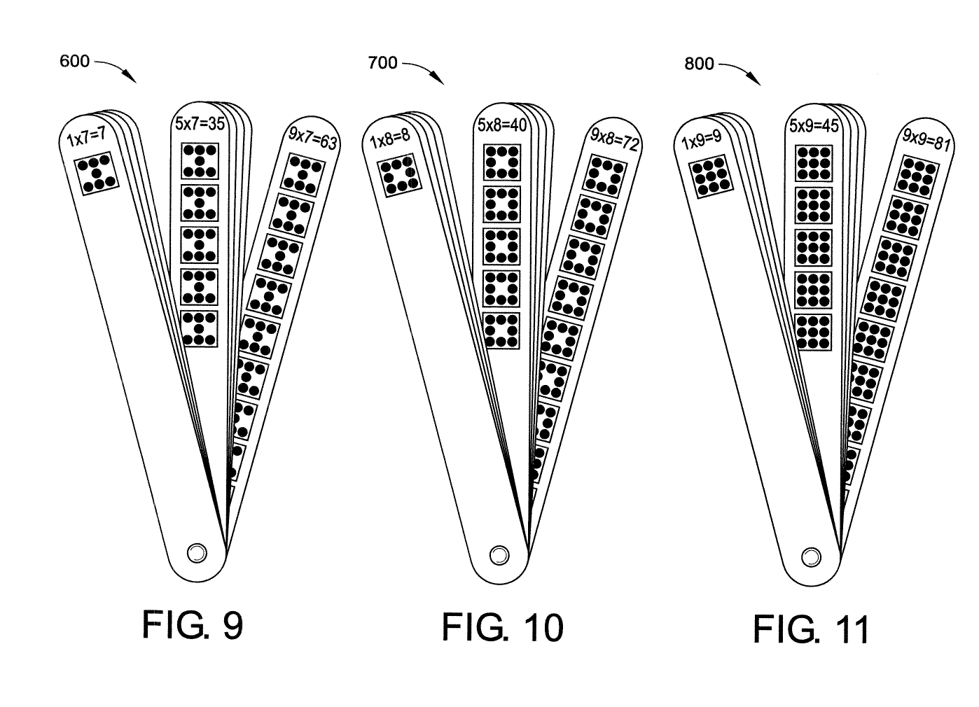

With reference to FIGS. 6-11, still other embodiments of a multiplication teaching aid 300, 400, 500, 600, 700, 800 are illustrated depicting, similar to the previously discussed embodiments, the multiplication “tables” or series for the numbers four (4), five (5), six (6), seven (7), eight (8) and nine (9), respectively. While only the ones, fives and nines tabs are visible in FIGS. 6-11, it should be understood that the remaining tabs (twos, threes, fours, sizes, sevens, and eights) are also provided for but are hidden from view in these figures. Also, it should be noted that while the teaching aids for the number series between two (2) and six (6) can utilize as one set of indicia the respective side of a playing die, no such playing die face exists for the remaining numbers seven (7), eight (8) and nine (9), as specifically illustrated in FIGS. 9-11. As such, the disclosed groupings of the indicia are unique in at least this respect.

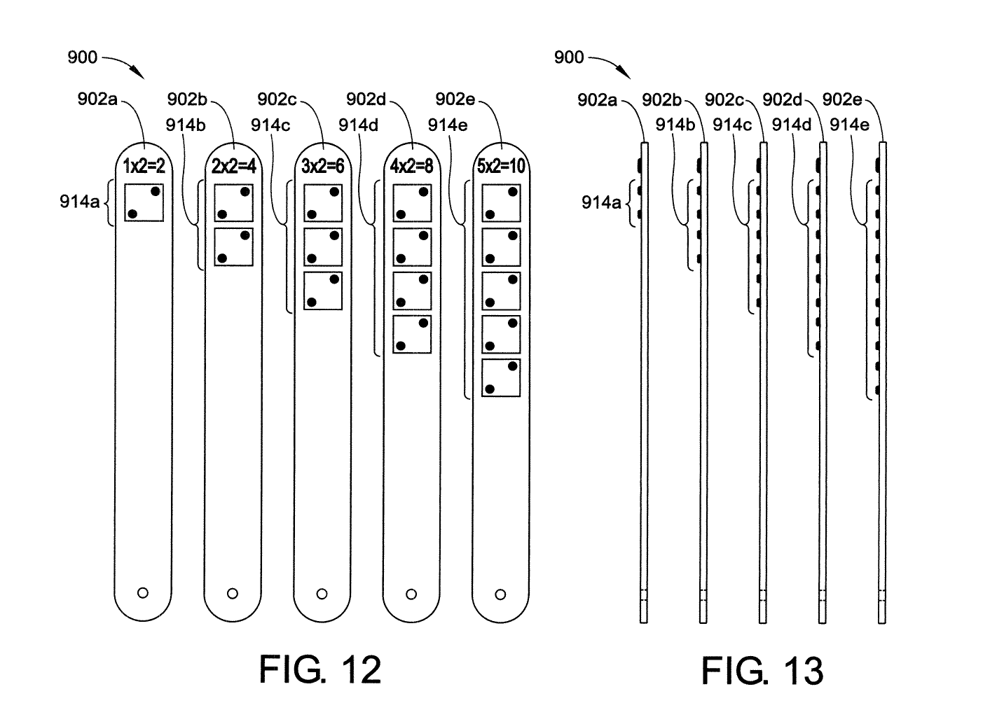

Lastly, with reference to FIGS. 12 and 13, yet another embodiment of a multiplication teaching aid 900 illustrates the use of raised or embossed lettering and/or indicia. Similar in nature to the previously discussed embodiments, the teaching aid 900 may include a plurality of tabs 902a-902e, each tab representing a particular number to be multiplied (e.g., two (2) through (5) as illustrated in FIG. 12) for a particular series or multiplication “table” (e.g., the twos (2's) multiplication tables as illustrated in FIG. 12). However, graphical representations, icons, and/or indicia 914a-914e of the numbers being multiplied on the respective tab are raised, elevated or otherwise displaced (e.g., forwardly or rearwardly) from the nominal face of the respective tab. This allows the student to “feel” the graphical representation, icon, or indicia of the numbers being multiplied and their resultant product. Such a teaching aid could be particularly suited to students which prefer more tactile learning techniques and/or those that are visually impaired.

It should be further noted that the plurality of tabs could be made in any general shape having dimensions that are suitable for the needs of a particular teaching environment. However, it has been found that tabs having a length of about 6″, a width of about ¾″ and a thickness of about 1/16″ is suitable in most cases. Moreover, the individual numbers to be multiplied could be made of wood, plastic or metal. Naturally, the tabs and or indicia displayed thereon can be presented in any variety or combination of colors and or the tabs and or teaching aids can be color coded to reflect the multiplication of a particular number series. Furthermore, the teaching aids could be made flat and/or in Braille to assist the visually impaired student. In addition, the individual indicia could be different, rather than being images of the individual surface of a playing die, they could be formed from other indicia that incorporate or can represent numerical values.

The exemplary embodiments have been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A teaching aid for facilitating in the learning and comprehension of multiplication tables, the teaching aid comprising:
a plurality of generally flat tabs including a front surface and a rear surface, at least one of the front surface or the rear surface capable of having indicia displayed thereon, the tabs including a first end and a second end, the second end including an aperture;
a retaining member extending through the aperture of the second end of each of the plurality of tabs for resiliently holding the plurality of tabs together while permitting each of the tabs to rotate with respect to the other; and
a plurality of indicia displayed on at least one of the front or rear surface of one of the plurality of tabs, the plurality of indicia including a first type of non-numerical indicia corresponding to a graphical representation of a first number to be multiplied and a second type of non-numerical indicia corresponding to a graphical representation of a second number to be multiplied, wherein the first and second sets of non-numerical indicia collectively represent the mathematical product of the first and second numbers.

2. The teaching aid according to claim 1, wherein the plurality of tabs can be collapsed so as to place the teaching aid in a closed state and wherein one or more of the individual plurality of tabs can be fanned out so as to place the teaching aid in a open state.

3. The teaching aid according to claim 1, wherein the first type of non-numerical indicia includes an icon of a playing die, and the second type of non-numerical indicia includes one or more dots within the icon of the playing die, the quantity of icons being representative of the first number to be multiplied and the quantity of dots being representative of the second number to be multiplied.

4. (canceled)

5. The teaching aid according to claim 1, wherein the indicia on the tabs are raised and project forwardly from the front or rear surface upon which they are displayed.

6. The teaching aid according to claim 1, wherein the indicia on the tabs are displayed in Braille.

7. The teaching aid according to claim 1, wherein the indicia are arranged in one of a geometric pattern including a square, triangle, star, columns, and rows.

8. The teaching aid according to claim 1, wherein the retaining member is an elongated cylindrical pin.

9. The teaching aid according to claim 1, wherein the retaining member is removable allowing for the addition or removal of one or more of the plurality of tabs.

10. A method of teaching a student how to multiply using a teaching aid, the method comprising:
providing the teaching aid with a plurality of tabs, the tabs bearing non-numeric indicia graphically representing the product of a first number to be multiplied by a second number to be multiplied, wherein the first number to be multiplied corresponds to a first set of non-numeric indicia and the second number to be multiplied corresponds to a second set of non-numeric indicia;
presenting the teaching aid to the student; and
explaining to the student the association of the product between the first number to be multiplied and the second number to be multiplied and the first set of corresponding indicia and the second set of corresponding indicia.

11. The method of claim 10, further providing that the indicia are in Braille.

12. The method of claim 10, further providing that the plurality of tabs are pinned together so that the plurality of tabs can be grouped according to a first number to be multiplied.

13. The method of claim 10, wherein the step of directing the student to study the plurality of tabs further includes directing the student to fan the tabs in a sequential order.

14. The method of claim 10, further providing a first set of indicia corresponding to a quantity of individual playing dies and a second set of indicia corresponding to a quantity of individual dots on each of the quantity of individual playing dies.

15. The method of claim 14, further including the step of directing the student to study the plurality of tabs further includes directing the student to count the individual dots on each of the of the quantity of individual playing dies on the respective tab.

16. The method of claim 14, wherein the quantity of individual dots are grouped in sets of twos, threes, fours, fives, sixes, sevens, eights, and nines for each of the respective tabs and wherein the step of explaining further includes directing the student to count the respective sets of grouped dots.
